(19) United States
(12) Patent Application Publication
(10) Pub. No.: US 2014/0283515 A1
(43) Pub. Date: Sep. 25, 2014

(54) SOLAR TURBINE POWER GENERATOR SYSTEM

(71) Applicant: Dan Boley, St. Marys, WV (US)

(72) Inventor: Dan Boley, St. Marys, WV (US)

(21) Appl. No.: 13/850,226

(22) Filed: Mar. 25, 2013

(51) Int. Cl. F03G 6/00

(52) U.S. Cl. CPC F03G 6/003
USPC 60/641.8

(57) ABSTRACT

A solar powered electrical generation system can produce electrical power by utilizing energy from the sun to vaporize liquids, such as bromine. The system of the present invention allows liquid to be vaporized by a heating unit powered by the sun. The vapor can travel to a condenser that is disposed at a height higher than a holding tank. The holding tank can collect liquid, which then drains back to the heating unit through a turbine. The turbine powers a generator to produce electricity. Because bromine has a high specific gravity (3.12 at 20° C.) and a relative low boiling point (58.8° C.), it may be ideal for use in the system of the present invention, where gravity provides the motive force of the condensed liquid through the turbine.

### BACKGROUND OF THE INVENTION

The present invention relates to power generation and, more particularly, to solar power generation.

Currently, solar power is in high demand and yet has not been very efficient. The efficiency of conventional methods of producing electrical power generated by solar energy is low. Conversely, the cost of conventional methods of obtaining electrical power generated by solar energy has been high.

As can be seen, there is a need for a solar powered electrical generation system that costs less and that can operate at a higher efficiency rate.

### SUMMARY OF THE INVENTION

In one aspect of the present invention, a solar powered electrical generation system comprises a solar heating unit; a condenser unit connected to the outlet of the solar heating unit; a liquid holding tank connected to the condenser unit; a turbine connected to the liquid holding tank; an electrical generator connected to a shaft of the turbine; and a backflow prevent device connected to outlet of the turbine, wherein the backflow prevent device is connected to inlet of the solar heating unit.

In another aspect of the present invention, a method of creating electrical generated power through solar energy comprises heating a liquid in a solar heating unit to create a vapor of the liquid; allowing the vapor to raise to a height above a liquid holding tank; allowing the vapor to condense within a condenser unit to a condensed liquid; collecting the condensed liquid in the liquid holding tank; draining the condensed liquid through a turbine and back to the solar heating unit; and turning an electrical generator by the turbine.

These and other features, aspects and advantages of the present invention will become better understood with reference to the following drawings, description and claims.

### BRIEF DESCRIPTION OF THE DRAWINGS

FIG. 1 is a schematic view of a solar powered electrical generation system according to an exemplary embodiment of the present invention; and

FIG. 2 is a flow chart describing an exemplary method of using the solar powered electrical generation system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a solar powered electrical generation system that can produce electrical power by utilizing energy from the sun to vaporize liquids, such as bromine. The system of the present invention allows liquid to be vaporized by a heating unit powered by the sun. The vapor can travel to a condenser that is disposed at a height higher than a holding tank. The holding tank can collect liquid, which then drains back to the heating unit through a turbine. The turbine powers a generator to produce electricity. Because bromine has a high specific gravity (3.12 at 20° C.) and a relative low boiling point (58.8° C.), it may be ideal for use in the system of the present invention, where gravity provides the motive force of the condensed liquid through the turbine.

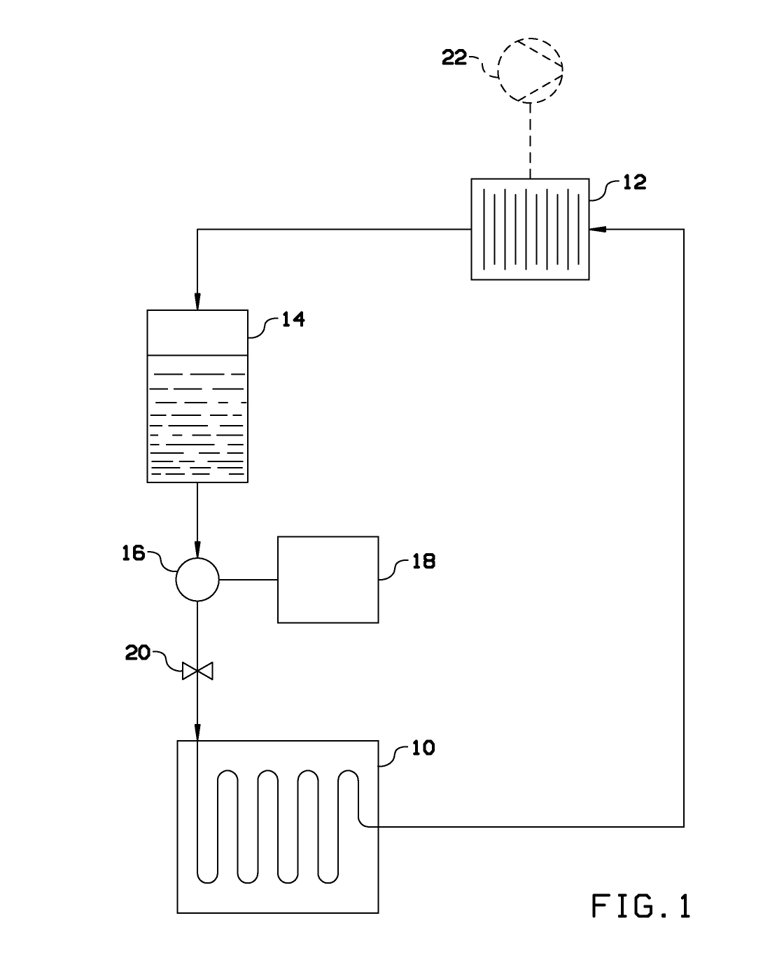

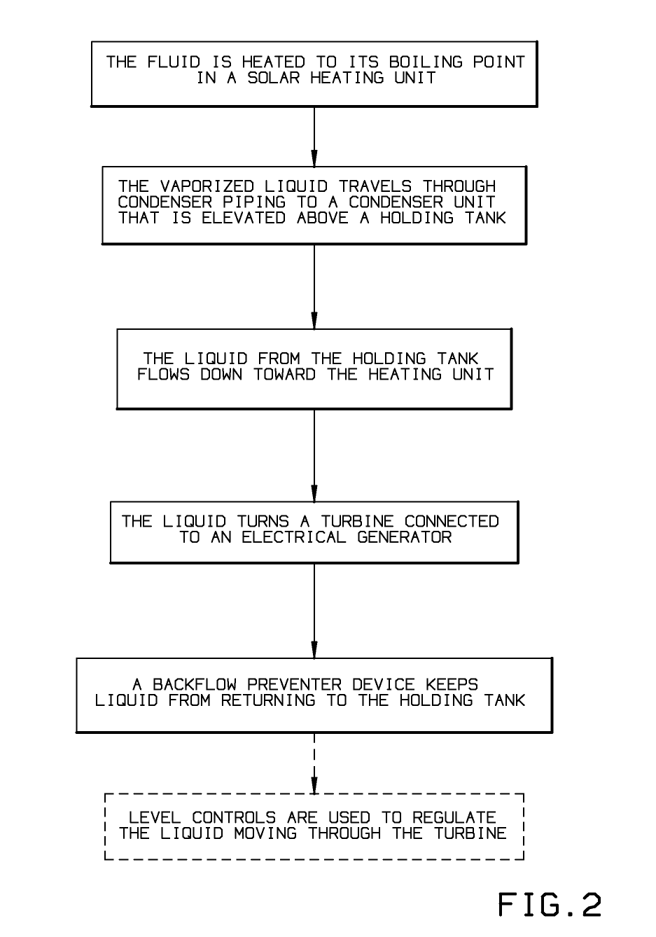

As is illustrated in FIGS. 1 and 2, the solar powered electrical generation system may include a solar heating unit 10. In certain embodiments, the solar heating unit 10 may be a solar oven. The outlet of the solar heating unit 10 may connect to a condenser unit 12 that is located at a height above the solar heating unit 10. The condenser unit 12 may be connected to a liquid holding tank 14 so that vapor formed in the solar heating unit 10 is condensed in the condenser unit 12 and the condensed liquid flows from the condenser unit 12 to the liquid holding tank 14.

The liquid holding tank 14 may be connected to a turbine 16 which in turn may be connected to an electrical generator 18 through the shaft of the turbine 16. The turbine 16 may be attached to a backflow prevent device 20. In certain embodiments, the backflow prevent device 20 may be a check valve. The backflow prevent device 20 is connected to the inlet of the solar heating unit 10, creating a loop. This loop is a closed loop so that neither the liquid nor the gas circulating about the loop is allowed to escape. Therefore, once charged with the appropriate liquid, such as bromine, the system can operate continuously.

In alternate embodiments, the present invention may also include a level controller on the liquid holding tank 14. A level controller would allow the unit to operate over a predetermined time frame which would allow the user more flexibility.

In some embodiments, a vacuum pump 22 can be installed in the system, typically at the condenser unit 12. The vacuum pump may reduce the pressure in the system to reduce the boiling point of the liquid, such as the bromine liquid, that is circulated in the system.

To use the system of the present invention, a user can charge an appropriate amount of fluid into the system. Various access ports can be provided to make this fluid addition. Once the fluid is added, the liquid in the solar heating unit 10 can be heated to its boiling point. The resulting vapor is carried to the condenser unit 12 where it is condensed back into a liquid. The condenser unit 12 is disposed at a raised height so that the condensed liquid can flow into the holding tank 14 and can be released through the turbine 16 to turn the generator 18. After passing through the turbine 16, the liquid returns to the solar heating unit 10 to be heated again, repeating the process.

In some embodiments of the present invention, heat captured from sun light vaporizes a particular liquid, such as bromine, at a low enough temperature to then condense in a condenser. In certain embodiments, a solar oven may be used which may reach temperatures of over 250 degrees Fahrenheit which is sufficient to vaporize many liquids. The invention utilizes the process of a liquid being evaporated and then condensing at a lower temperature.

The system of the present invention may be used in all locations and, depending on the liquid and size of the solar heating unit, the system of the present invention may be used for individual homes or on a commercial scale. The liquid is passed through the system changing phases as it is processed within the system, thereby generating power. This drives down the costs of the invention to something significantly lower than traditional types of solar power.

It should be understood, of course, that the foregoing relates to exemplary embodiments of the invention and that modifications may be made without departing from the spirit and scope of the invention as set forth in the following claims.

What is claimed is:

1. A solar powered electrical generation system comprising:
a solar heating unit;
a condenser unit connected to outlet of the solar heating unit;
a liquid holding tank connected to the condenser unit;
a turbine connected to the liquid holding tank;
an electrical generator connected to a shaft of the turbine; and
a backflow prevent device connected to outlet of the turbine, wherein the backflow prevent device is connected to inlet of the solar heating unit.

2. The solar powered electrical generation system of claim 1, further comprising bromine charged into the solar heating unit.

3. The system of claim 1, wherein the backflow prevent device is a check valve.

4. The system of claim 1, further comprising a level controller attached to the liquid holding tank.

5. The system of claim 1, further comprising a vacuum pump connected to the condenser unit.

6. The system of claim 4, wherein the level controller includes a level control valve connected to the condenser unit.

7. A method of creating electrical generated power through solar energy comprising the steps of:
heating a liquid in a solar heating unit to create a vapor of the liquid;
allowing the vapor to raise to a height above a liquid holding tank;
allowing the vapor to condense within a condenser unit to a condensed liquid;
collecting the condensed liquid in the liquid holding tank;
draining the condensed liquid through a turbine and back to the solar heating unit; and
turning an electrical generator by the turbine.

8. The method of claim 7, further comprising passing the liquid through a backflow prevent device, thereby ensuring the liquid and the liquid vapor follow the direction towards the solar heating unit.

9. The method of claim 7, wherein the liquid is bromine.

10. The method of claim 7, further comprising reducing pressure to reduce a boiling point of the liquid.
